(19) United States
(12) Patent Application Publication
(10) Pub. No.: US 2026/0312093 A1
(43) Pub. Date: Oct. 8, 2026

(54) METHOD FOR OPERATING A FUEL CELL SYSTEM, AND CONTROL DEVICE

(71) Applicant: Robert Bosch GmbH, Stuttgart (DE)

(72) Inventor: Helerson Kemmer, Vaihingen (DE)

(21) Appl. No.: 19/483,724

(22) PCT Filed: May 10, 2024
(86) PCT No.: PCT/EP2024/062924

§ 371 Date: Nov. 12, 2025

(30) Foreign Application Priority Data
May 17, 2023 (DE) 10 2023 204 653.9

(51) Int. Cl. H01M 8/04492; H01M 8/04007; H01M 8/04029; H01M 8/04223; H01M 8/04228; H01M 8/0432

(52) U.S. Cl. CPC H01M 8/04492; H01M 8/04029; H01M 8/04037; H01M 8/04228; H01M 8/04253; H01M 8/0432

(57) ABSTRACT

The invention relates to a method for operating a fuel cell system (1), in which method a gaseous fuel, in particular hydrogen, is supplied to the anode side of a fuel cell stack (2) of the fuel cell system (1), and air as an oxygen supplier is supplied to the cathode side, and in which method the following steps are carried out before the fuel cell system (1) is shut down:
a) determining at least one parameter within the fuel cell system (1) and comparing said at least one parameter with at least one predefined first threshold value;
b) activating at least one device in order to release thermal energy at a critical point and/or component (3,4) within the fuel cell system (1) if the first threshold value has been undershot; and
c) initiating a drying procedure.

The invention also relates to a control device (10) for a fuel cell system (1).

### BACKGROUND

The invention relates to a method for operating a fuel cell system, and a control device configured to perform steps of the method.

A fuel cell converts a fuel, for example hydrogen, and oxygen into electrical energy, heat and water. To increase performance, a plurality of fuel cells are usually connected to form a fuel cell stack and supplied with the reaction gases via supply channels running through the fuel cell stack. As a rule, air taken from the surrounding environment and fed to a cathode of the fuel cell stack serves as the oxygen source. The fuel required by an anode of the fuel cell stack is stored in a suitable tank or storage system and metered with the aid of a metering valve. To conserve fuel, depleted fuel leaking from the fuel cells may be recirculated via an anode circuit. The recirculation process can be achieved passively using a jet pump integrated into the anode circuit and/or actively using a recirculation fan integrated into the anode circuit. All the components together form a fuel cell system.

The water produced during operation of a fuel cell system may freeze at low ambient temperatures in the case of shut down if it is not separated and drained off. When the fuel cell system is restarted, especially under freezing conditions, there is then a risk that the ice will block the supply of the required reaction gases to the fuel cells. During operation of a fuel cell system, liquid water is therefore removed from the system using a water separator. After shutdown, however, water contained in the reaction gases may condense in the form of water vapor due to further cooling of the system, so that there is still a risk of ice formation at low ambient temperatures. In addition, when starting under cold or freezing conditions, the fuel cells must first be brought to operating temperature.

The object of the present invention is to therefore improve the starting capability of a fuel cell system under cold or freezing conditions. To solve this problem, the method according to the disclosure is proposed. Advantageous embodiments of the invention can be gathered from the dependent claims. A control device for carrying out steps of the method according to the invention is also specified.

### SUMMARY

In the proposed method for operating a fuel cell system, a gaseous fuel, in particular hydrogen, is supplied to the anode side of a fuel cell stack of the fuel cell system, and air as an oxygen supplier is supplied to the cathode side. Prior to shutting down the fuel cell system, the following steps are performed:
a) determining at least one parameter within the fuel cell system and comparing said at least one parameter to at least one predetermined first threshold value;
b) activating at least one device in order to release thermal energy at a critical point and/or component within the fuel cell system if the first threshold value has been undershot; and
c) initiating a drying procedure.

With the aid of the proposed method, the fuel cell system may be shut down in a particularly safe and efficient manner, particularly in a manner compliant with starting under freezing conditions. The method may preferably be used for short-haul trips in which critical areas have not been sufficiently heated. Typically, in particular during longer trips or high outside temperatures, the anode system and cathode system are heated through by the previous operation, which favors drying. In special cases, such as during short-haul trips (“quick trips to the shops”), the operating time is not sufficient for heating up the air system or anode system.

During the drying phase, the fuel cell stack is dried well, as it reaches the required operating temperature of approximately 65 °C relatively quickly. Due to the still cold surfaces in the rest of the system, the water removed or blown out from the fuel cell stack can condense on critical components or points of the air or anode system and subsequently freeze. This results in a delay got a start under freezing conditions, as the frozen points and/or components need to be thawed first.

The method according to the invention may avoid unwanted delays during a start under freezing conditions. The method according to the invention ensures that when the fuel cell system is switched off, no critical points and/or components with low temperatures lead to a condensation of water, so that a layer of ice is formed at these critical points and/or components, which impedes a subsequent start.

By determining, at least one parameter within the fuel cell system in step a) and comparing that at least one parameter with at least a predefined first threshold value, it is possible to check whether there are critical points and/or components within the fuel cell system where water may condense during a drying procedure.

By activating at least one device in order to release thermal energy at a critical point and/or component within the fuel cell system in step b), the critical points and/or components are heated up before a drying procedure is initiated in step c).

Advantageous configurations and further developments of the device according to the invention for reducing a hydrogen concentration in an exhaust gas of a fuel cell system are specified in the dependent claims.

It is advantageous to wait for a predefined time after activating the at least one device in order to release thermal energy at a critical point and/or component before step c), as the critical points and/or components may heat up during the predefined time.

It is advantageous if, in step a), the at least one parameter is a switch-on time of the fuel cell system and it is compared to a first threshold value of time, as in this way it can be checked whether the critical points and/or components in the fuel cell system have had enough time to warm up. It is particularly advantageous if the first threshold value of the time is determined as a function of the ambient temperature, as at particularly low ambient temperatures, the time required to heat up the critical points and/or components is longer.

Due to the high accuracy and the possibility of individually assessing the individual points, it is advantageous if in step a) the at least one parameter is an actual temperature on the anode side and/or cathode side and this is compared with a first threshold value of the temperature. Here, the actual temperature on the anode side and/or cathode side within the fuel cell system may be sensed using at least one temperature sensor.

It is advantageous if at least one heater arranged on the anode and/or cathode side is/are activated in step b), as this enables local heating of the critical points and/or components. Alternatively, in step b), at least one cooling circuit may be coupled to the critical point and/or component.

A heat quantity calculation over time and/or by means of temperature scanning, which is used to determine the time at which the drying procedure is initiated, is particularly advantageous, as steps a) and b) do not have to be repeated and it is possible to go directly to step c).

At least one electrical heater, for example a PTC heating element and/or a resistance heater, can preferably be used when carrying out the method according to the invention. Electric heaters require little installation space and are also particularly robust, so that they can be integrated into the fuel cell system almost anywhere. The PTC heating element also has the advantage that it is self-regulating so as to prevent overheating. When using a resistive heater, this can be countered by controlling the temperature of the resistive heater by means of a temperature sensor. This may be integrated into the resistive heater.

The at least one electric heater may preferably be supplied with electrical power via a battery. In mobile applications, the battery may in particular be a vehicle battery.

In addition, a control device for a fuel cell system is proposed, which is configured to carry out steps of the method according to the invention. The method can be largely automated using the control device. The respective threshold values are preferably stored in the control device for this purpose. Depending on the result of the comparison or the comparisons, the control device can be used to activate the at least one device for the release of thermal energy.

### BRIEF DESCRIPTION OF THE DRAWINGS

The invention is described in more detail below with reference to the accompanying drawings. Shown are:

FIG. 1 a schematic illustration of a fuel cell system which is suitable for carrying out a method according to the invention, and

FIG. 2 a block diagram showing the sequence of a method according to the invention.

### DETAILED DESCRIPTION

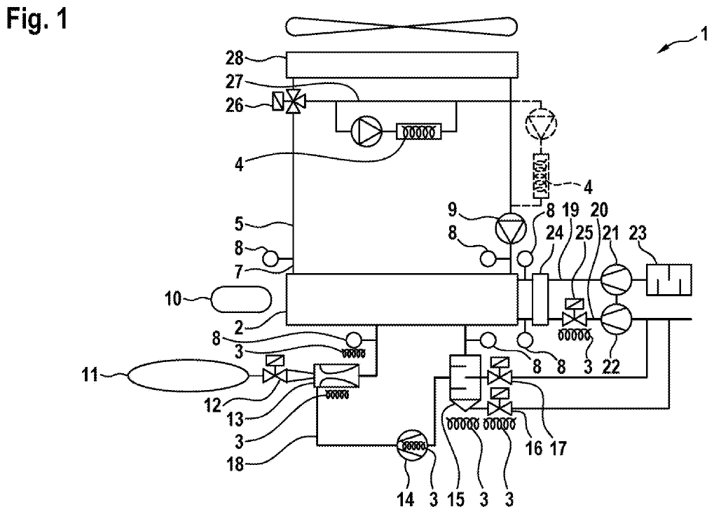

The fuel cell system 1 shown in FIG. 1 comprises a fuel cell stack 2, which is supplied with a fuel, for example hydrogen, on the anode side and air as an oxygen supplier on the cathode side during operation of the system.

The fuel is stored in a tank 11 and metered into an anode circuit 18 using a metering valve 12. Via the anode circuit 18, not only fresh fuel is supplied to the fuel cell stack 2 as anode gas, but also recirculated anode gas. For passive recirculation, a jet pump 13 is integrated into the anode circuit 18. Further, a recirculation fan 14 is provided, with the help of which the anode gas can be actively recirculated. As anode gas leaking out of the fuel cell stack 2 may contain liquid water, it is previously supplied to a water separator 15. When full, a drain valve 16 may be opened to drain. By opening a purge valve 17, the anode circuit may be purged.

The air supplied by the fuel cell stack 2 is taken from the surroundings and first supplied to an air filter 23. The air is then compressed with the aid of an air compressor 21, as the electrochemical process in the fuel cells requires a certain air mass flow as well as a certain pressure level. The air compressor 21 is arranged downstream of the air filter 23 in a cathode supply air path 19. A turbine 22, which serves to drive the air compressor 21 or supports an electric motor drive (not shown) of the air compressor 21, is arranged in a cathode exhaust air supply path 20, via which the air exiting from the fuel cell stack 2 is discharged. With the help of the turbine 22, a portion of the energy used to compress the air can thus be recovered. The cathode supply air path 19 and the cathode exhaust air path 20 are also connected via another component. This may be a humidification device 24, for example in the form of a membrane humidifier, and/or a heat exchanger. With the help of the further component, the humidity and/or the temperature of the air in the cathode supply air path 19 can be adjusted.

The fuel cell stack 2 shown is also connected to a cooling circuit 5, which serves to cool the fuel cell stack 2 during operation of the system. The cooling circuit comprises a coolant pump 9 for conveying a coolant through the fuel cell stack 2. A directional control valve 26 is also integrated into the cooling circuit 5 for switching a bypass path 27, which is used to bypass a vehicle radiator 28.

Temperature sensors 8 are integrated into the cooling circuit 5 in the area of an inlet 6 into the fuel cell stack 2 and in the area of an outlet 7 from the fuel cell stack 2. Further temperature sensors 8 can be found in the anode circuit 18 and the cathode supply air path 19 and in the cathode exhaust air path 20, in the inlet and outlet areas respectively. The temperature sensors 8 can be used to detect the actual temperatures on the anode side and/or cathode side of the reaction gases as well as the coolant. The core temperature of the fuel cell stack 2 can in turn be deduced from the coolant temperature.

The temperature sensors 8 shown in FIG. 1 provide their measured values to a control device 10, which compares them—particularly when the system is switched off—with the first threshold values stored in the control device 10. If the comparison shows that at least one of the first threshold values is undershot, at least one heater 3, 4 is activated.

In FIG. 1 shows an example of a plurality of heaters 3, 4, which do not necessarily all have to be present. Further, the locations are merely exemplary selected and may be altered.

First heaters 3 are integrated on the anode side in components at risk of icing. These are the jet pump 13, the recirculation fan 14, the water separator 15, the drain valve 16 and the temperature sensor 8 arranged on the entry side. Another first heater 3 is integrated into a valve 25 on the cathode side, which is arranged in the cathode exhaust path 20.

At least a second heater 4 is integrated into the cooling circuit 5, namely in the area of a pump integrated into the bypass path. Alternatively, the heater 4 may also be arranged in the area of the coolant pump 9 or at any other location in the cooling circuit 5. This position is indicated in FIG. 1. By activating at least one heater 3, 4, the fuel cell system 1 can be specifically heated at critical points and/or components when the system is shut down.

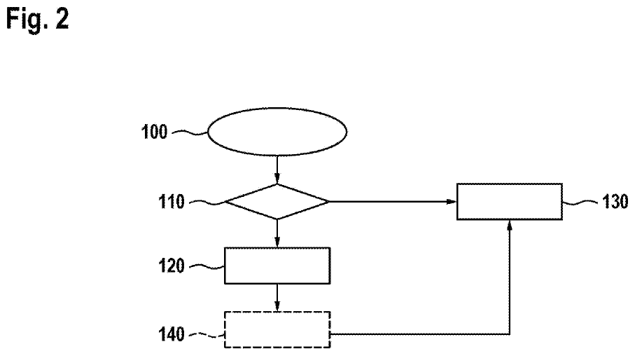

The method according to the invention for operating a fuel cell system, in particular for shutting down, will be explained below with reference to FIG. 2.

As soon as the control device 10 receives the “Shutdown” command (step 100), a parameter within the fuel cell system 1 is first determined using the control device 10.

This parameter may be an actual temperature on the anode side and/or cathode side. Preferably, the actual temperature on the anode side and/or cathode side is determined at critical points and/or components within the fuel cell system 1.

Critical points and/or components within the fuel cell system 1 are areas within the fuel cell system 1 that heat up more slowly than the rest of the fuel cell system 1. At the critical points and/or components, the water removed or blown out of the stack from the air or H2 system can condense and even freeze due to the still cold surfaces.

The at least one parameter is then compared to at least one predefined first threshold value in method step 110. If the at least one parameter is the actual temperature on the anode side and/or cathode side, then it is compared with a first threshold value of the temperature.

In an alternative embodiment, the parameter may be a switch-on time of the fuel cell system since startup. The switch-on time is then compared to a first threshold value of time in method step 110.

The first threshold value of time may be fixed or determined depending on the ambient temperature of the fuel cell system.

If the parameter is less than the first threshold value, in a method step 120, at least one device for releasing thermal energy is activated at a critical point and/or component 3 within the fuel cell system 1.

If the parameter is greater than the first threshold value, a drying procedure is initiated in a method step 130, as there are no critical points, components or areas within the fuel cell system 1 that could condense a temperature on the water.

After the method step 120, an optional method step 140 may be performed in which a predefined time is waited for after activating the at least one device for releasing thermal energy at a critical point and/or component 3 before performing method step 130.

The device for releasing thermal energy at a critical point and/or component 3 may be at least one heater arranged on the anode side and/or cathode side, which is activated in method step 120.

Alternatively or additionally, at least one cooling circuit may be coupled to the critical point and/or component. To increase the cooling circuit to the desired temperature, a further heater in the 4th in the cooling circuit may be activated. To couple the cooling circuit to the critical point and/or component, a valve may be opened so that heated cooling liquid from the cooling circuit flows to the critical point and/or components. For example, the at least one electric heater 3, 4 may be a PTC heater element and/or a resistive heater, which is preferably powered by electrical power via a battery.

After activation of the at least one delivery device in order to release thermal energy at a critical point and/or component 3, the time when the drying procedure is initiated may be determined by a heat quantity calculation over time and/or by temperature scanning.

1. A method for operating a fuel cell system (1), in which method a gaseous fuel is supplied to an anode side of a fuel cell stack (2) of the fuel cell system (1), and air as an oxygen supplier is supplied to a cathode side, and in which method the following steps are carried out before the fuel cell system (1) is shut down:
a) determining a parameter within the fuel cell system (1) and comparing said parameter with a predefined first threshold value;
b) activating a device to release thermal energy at a critical point and/or component (3,4) within the fuel cell system (1) if the first threshold value has been undershot; and
c) initiating a drying procedure.

2. The method according to claim 1, wherein after activating the device to release thermal energy at a critical point and/or component (3,4), a predefined time is waited for before step c) is performed.

3. The method according to claim 1, wherein in step a), the parameter is a switch-on time of the fuel cell system and is compared to a first threshold value of time.

4. The method according to claim 3, wherein the first threshold value of time is determined depending on ambient temperature.

5. The method according to claim 1, wherein in step a), the parameter is an actual temperature on the anode side and/or cathode side and is compared with a first threshold value of temperature.

6. The method according to claim 1, wherein an actual temperature on the anode side and/or cathode side within the fuel cell system (1) is sensed using a temperature sensor (8).

7. The method according to claim 1, wherein in step b), a heater (3) arranged on the anode side and/or cathode side is activated.

8. The method according to claim 1, wherein in step b) a cooling circuit is coupled to the critical point and/or component.

9. The method according to claim 1, wherein the point in time when the drying procedure is initiated is determined by a heat quantity calculation over time and/or by temperature scanning.

10. A control device for a fuel cell system (1), which is configured to carry out steps of a method according to claim 1.
